(19) United States
(12) Patent Application Publication
(10) Pub. No.: US 2003/0070456 A1
(43) Pub. Date: Apr. 17, 2003

(54) Covered latch mechanism

(76) Inventor: Paul Zamberg, Fountain Valley, CA (US)

Correspondence Address: STETINA BRUNDA GARRED & BRUCKER, 75 ENTERPRISE, SUITE 250, ALISO VIEJO, CA, 92656, US

(21) Appl. No.: 09/976,984

(22) Filed: Oct. 12, 2001

(51) Int. Cl. E05B 13/00

(52) U.S. Cl. 70/208

(57) ABSTRACT

The present invention is a covered latch assembly. The covered latch assembly includes a recessed latch housing that supports a retractable latch and a stationary catch. The covered latch assembly comprises a cover assembly that is pivotally attached to the latch housing. The cover assembly is pivotable between an access position wherein the latch is exposed and can be grasped and a secure position wherein the latch is shrouded and cannot be grasped.

### CROSS-REFERENCE TO RELATED APPLICATIONS

(Not Applicable) STATEMENT RE: FEDERALLY SPONSORED RESEARCH/DEVELOPMENT

(Not Applicable)

### BACKGROUND OF THE INVENTION

The present invention relates generally to latches, and more particularly to a latch mechanism having a locking cover for preventing access to the latch.

There is currently known in the prior art a wide variety of latch assemblies which are used to secure adjacent members to each other, such as the lid and body of an equipment case. When used for this particular application, a plurality of latch assemblies are typically spaced along the parting line between the lid and the body of the equipment case. Typical prior art latch assemblies each include a striker plate assembly and a bolt assembly which are mounted to the lid and body, respectively. The bolt assembly typically includes an arm assembly, one end of which is pivotally connected to a bracket secured to the floor of a bolt half cup. The arm assembly itself includes a bolt which slidably extends from one end thereof and is engageable to a striker plate of the striker plate assembly. The striker plate itself typically resides in a striker half cup of the striker plate assembly. The extension and retraction of the bolt from the arm assembly is typically controlled by the rotation of a key which is rotatably connected to the arm assembly. The key is rotatable to a stowed position so as to be substantially enclosed within the bolt half cup to protect it from accidental engagement with other equipment and/or personnel when the lid is secured to the body of the equipment case.

While the use of the recessed half cup helps to protect from accidental engagement with other equipment and/or personnel, it does not totally alleviate the problem. Furthermore, the latch is not protected from people who should not have access to the latch.

These particular deficiencies are overcome by the latch assembly of the present invention which employs a cover to protect the latch.

### BRIEF SUMMARY OF THE INVENTION

In accordance with the present invention, there is provided a latch assembly. The latch assembly includes a recessed latch housing that supports a retractable latch and a stationary catch. The latch assembly comprises a cover assembly that is pivotally attached to the latch housing. The cover assembly is pivotable between an access position wherein the latch is exposed and can be grasped and a secure position wherein the latch is shrouded and cannot be grasped.

In accordance with other aspects of the present invention, the cover assembly is attached to the latch assembly using at least one hinge. The at least one hinge may be recessed below an upper surface of the recessed latch housing.

In accordance with yet other aspects of the present invention, the cover assembly may comprises a lock assembly. The lock assembly may comprise an engagement tab that engages with the latch assembly to hold the cover assembly in the secure position.

In accordance with still other aspects of the present invention, the cover assembly may be substantially “U” shaped.

In accordance with further aspects of the present invention, the cover assembly may be substantially coplanar with an upper surface of the recessed latch housing.

### BRIEF DESCRIPTION OF THE DRAWINGS

These, as well as other features of the present invention, will become more apparent upon reference to the drawings wherein:

FIG. 1 is a top perspective view of the covered latch assembly of the present latch mechanism with the cover open;

FIG. 2 is a view of the covered latch assembly shown in FIG. 1 with the cover closed;

FIG. 3 illustrates an alternative embodiment of the covered latch assembly shown in FIG. 2 with recessed hinges and a recessed lock mechanism; and

FIG. 4 is a top perspective view of an embodiment of the covered latch assembly of the present latch mechanism where the latch assembly employs magnets.

### DETAILED DESCRIPTION OF THE INVENTION

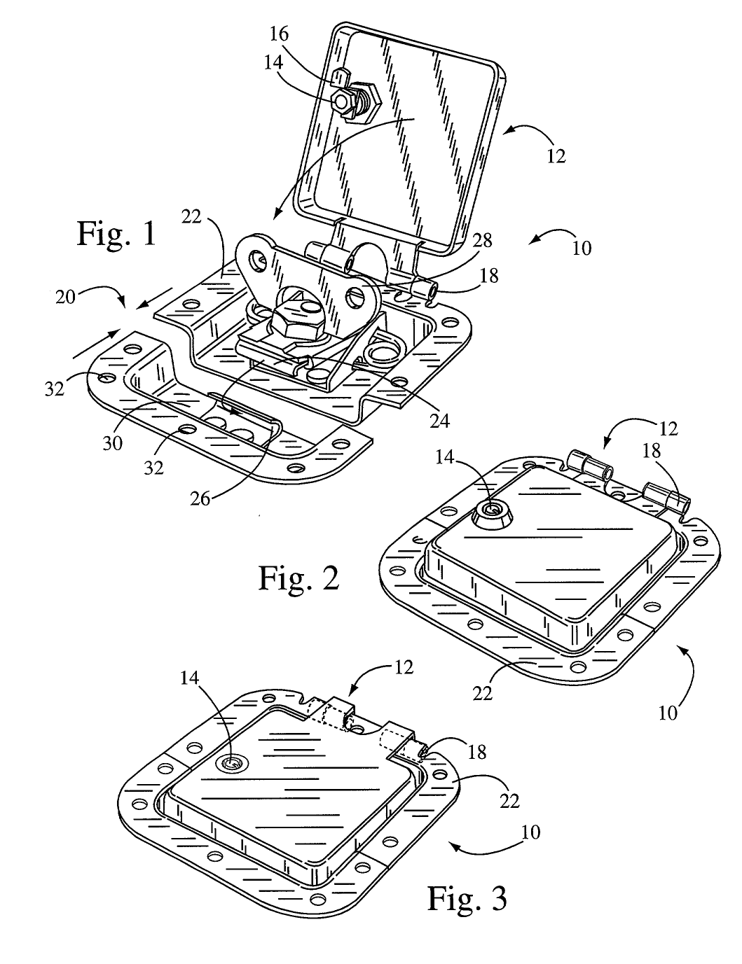

Referring now to the drawings wherein the showings are for purposes of illustrating preferred embodiments of the present invention only, and not for purposes of limiting the same, FIG. 1 is a top perspective view of a covered latch assembly 10 formed in accordance with the present invention. The latch assembly 10 of the present invention includes a latch 24 configured to securely engage to a catch 26. In the exemplary embodiment shown in FIG. 1, latch 24 is a retractable latch having a curved end which secures to a stationary catch 26 with a complementary curved end. The retractable latch 24 and stationary catch 26 are attached to a bottom surface 30 of a recessed latch housing 20. The recessed latch housing 20 also includes an upper surface 22 or flange which is substantially parallel to the bottom surface 30 of the recessed latch housing 20. The latch assembly 10 of the present invention can be attached to a surface, such as that of an equipment case using a securing device, such as a screw or bolt which can be placed through an apperture 32 on the upper surface 22 of the recessed latch housing 20.

The covered latch assembly 10 shown in FIG. 1 is in an unlocked position. In the unlocked position, the latch 24 and the catch 26 are not engaged. The latch 24 can be moved to a locked position by engaging the retractable latch 24 with the stationary catch 26. A key 28 is then used to secure the latch 24 in the lock position. For example, the key 28 is rotated and then moved from a vertical position such as that shown in FIG. 1 to a horizontal position. When the key 28 is in the horizontal position, a cover assembly 12 can be closed so that the latch 24 can not be accessed.

FIGS. 2 and 3 show the latch assembly 10 of FIG. 1 with the cover assembly 12 in a secure position that shrouds the latch 24 so that the latch can not be grasped. In the exemplary embodiment shown in FIGS. 1 and 2, the hinges 18 that are attached to the upper surface 22 of the recessed latch housing 20 pivotally connect the cover assembly 12 to the recessed latch housing 20.

A lock mechanism 14 is used to secure the cover assembly 12 in the closed position shown in FIG. 2. The exemplary lock assembly 14 shown in FIG. 2 is a raised lock assembly that uses a key to secure the cover assembly 12 in place. As can be seen in FIG. 1, lock assembly 14 may have an engagement tab 16 which when turned engages with latch 24 so that the cover assembly 12 is held securely in place when the cover is in the closed and locked position.

In alternative embodiments, hinges 18 may be lowered or recessed as shown in FIG. 3. Lowering the hinges may be desired to keep the covered latch assembly as planar as possible to prevent damage either to the covered latch assembly 10 or to anything that comes in contact with the covered latch assembly 10.

The cover assembly 12 shown in FIGS. 1 and 2 is a raised, U-shaped cover. Other configurations may be used in alternative embodiments. For example, as shown in FIG. 3, the cover may be coplanar with the upper surface 22 of the latch housing 20.

Alternative embodiments may have different lock assemblies than those shown in FIG. 2. For example, as shown in FIG. 3, lock assembly 14 may be flush with the cover assembly 12. The lock assembly may be a key lock, such as that shown in the figures. Alternative locks, such as those secured by magnets, may also be employed.

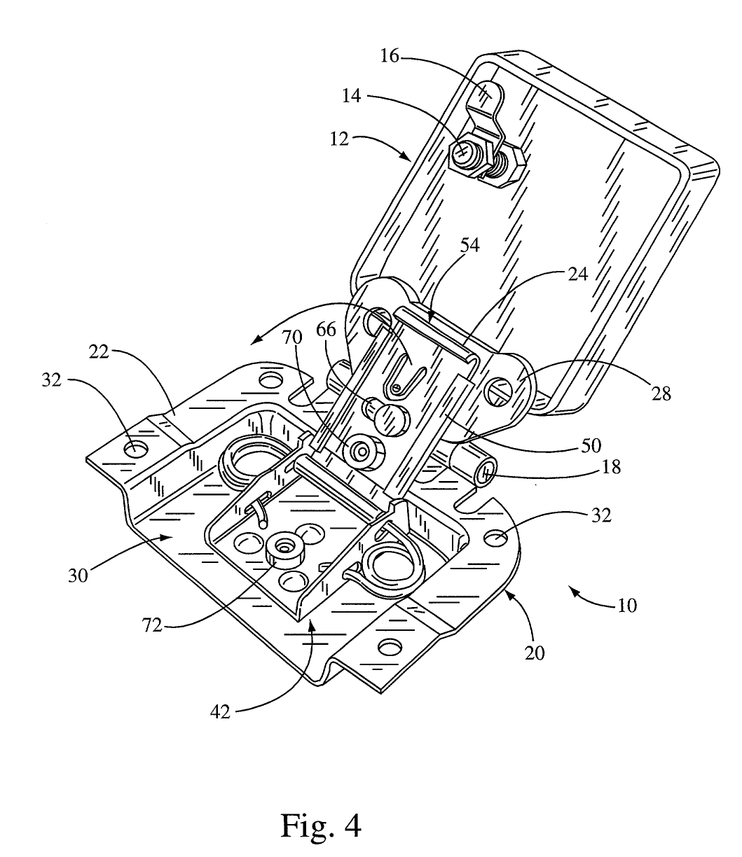

The covered latch assembly of the present invention can be implemented with various latch mechanisms. In exemplary embodiments, a latch mechanism employing magnets, such as the one shown in FIG. 4 is used. The latch mechanism shown in FIG. 4 is fabricated from a ferrous material, such as stainless steel. The exemplary covered latch assembly 10 shown in FIG. 4 comprises a circularly configured first magnet 70 which is attached to the inner surface of a bolt 54 between the proximal end of the bolt 54 and a cam slot 66 formed therein. Attached to the support bracket 42 is a circularly configured second magnet 72. The first and second magnets 70, 72 are oriented relative to each other such that the first magnet 70 is magnetically repelled by the second magnet 72 when the bolt 54 is moved to its unlatched position. This force of magnetic repulsion has the effect of biasing an arm 50 to its outward position. Conversely, when the bolt 54 is moved to its latched position, the first magnet 70 is magnetically attracted to the ferrous support bracket 42. This force of magnetic attraction has the effect of drawing the arm 50 to its inward position.

Additional modifications and improvements of the present invention may also be apparent to those of ordinary skill in the art. Thus, the particular combination of parts described and illustrated herein is intended to represent only one embodiment of the present invention, and is not intended to serve as limitations of alternative devices within the spirit and scope of the invention.

What is claimed is:

1. An improved latch mechanism of the type in which a latch assembly having a recessed latch housing supporting a retractable latch and a stationary catch, wherein the improvement comprises:
a cover assembly pivotally attached to the latch housing, the cover assembly being pivotable between an access position wherein the latch is exposed and can be grasped and a secure position wherein the latch is shrouded and cannot be grasped.

2. The improved latch mechanism of claim 1, wherein the cover assembly is attached to the latch assembly using at least one hinge.

3. The improved latch mechanism of claim 2, wherein the at least one hinge is recessed below an upper surface of the recessed latch housing.

4. The improved latch mechanism of claim 1, wherein the cover assembly comprises a lock assembly.

5. The improved latch mechanism of claim 4, wherein the lock assembly comprises an engagement tab that engages with the latch assembly to hold the cover assembly in the secure position.

6. The improved latch mechanism of claim 1, wherein the cover assembly is substantially “U” shaped.

7. The improved latch mechanism of claim 1, wherein the cover assembly is substantially coplanar with an upper surface of the recessed latch housing.

8. A covered latch mechanism including a latch assembly having a recessed latch housing supporting a retractable latch and a stationary catch, wherein the covered latch mechanism comprises:
a cover assembly pivotally attached to the latch housing, the cover assembly being pivotable between an access position wherein the latch is exposed and can be grasped and a secure position wherein the latch is shrouded and cannot be grasped.

9. The covered latch mechanism of claim 8, wherein the cover assembly is attached to the latch assembly using at least one hinge.

10. The covered latch mechanism of claim 8, wherein the cover assembly comprises a lock assembly.

11. The covered latch mechanism of claim 10, wherein the lock assembly comprises an engagement tab that engages with the latch assembly to hold the cover assembly in the secure position.

12. The covered latch mechanism of claim 8, wherein the cover assembly is substantially “U” shaped.

13. The covered latch mechanism of claim 8, wherein the cover assembly is substantially coplanar with an upper surface of the recessed latch housing.

14. A covered latch mechanism comprising:
a latch assembly having a recessed latch housing;
a retractable latch and a stationary catch supported by the latch assembly, the latch being moveable between a latched position in which the latch is cooperatively engaged with the catch and an unlatched position in which the latch is not cooperatively engaged with the catch; and
a cover assembly pivotally attached to the latch assembly, the cover assembly being pivotable between an access position wherein the latch is exposed and can be grasped and a secure position wherein the latch is shrouded and cannot be grasped.

15. The covered latch mechanism of claim 14, wherein the latch assembly further comprises:
a first magnet attached to the latch; and
a second magnet attached to the latch housing;
the first and second magnets being oriented relative to each other such that the first magnet is magnetically repelled by the second magnet when the latch is moved to the unlatched position, and the first magnet is magnetically attracted to the housing when the latch is moved to the latched position.

16. The covered latch mechanism of claim 14, wherein the cover assembly is attached to the latch assembly using at least one hinge.

17. The covered latch mechanism of claim 14, wherein the cover assembly comprises a lock assembly.

18. The covered latch mechanism of claim 17, wherein the lock assembly comprises an engagement tab that engages with the latch assembly to secure the cover assembly in the secure position.

19. The covered latch mechanism of claim 14, wherein the cover assembly is substantially “U” shaped.

20. The covered latch mechanism of claim 14, wherein the cover assembly is substantially coplanar with an upper surface of the recessed latch housing.
